(19) United States
(12) Patent Application Publication
(10) Pub. No.: US 2024/0417596 A1
(43) Pub. Date: Dec. 19, 2024

(54) PLASTIC SOFT COMPOSITION AND SCUFFING PROCESSING METHOD

(71) Applicant: JOYBOND CO., LTD., Saitama (JP)

(72) Inventor: Tadao KODATE, Saitama (JP)

(21) Appl. No.: 18/746,360

(22) Filed: Jun. 18, 2024

(30) Foreign Application Priority Data
Jun. 19, 2023 (JP) 2023-099936

(51) Int. Cl. C09G 1/16; B24B 7/19; C08K 3/11; C08K 3/22; C09G 1/02

(52) U.S. Cl. CPC C09G 1/16; B24B 7/19; C08K 3/11; C08K 3/22; C09G 1/02; C08K 2003/2227

(57) ABSTRACT

A plastic soft composition and a scuffing processing method using it, which include a flexible base material having plasticity, a particulate abrasive contained in the flexible base material and having an average particle size of 10 μm or more and 1.5 mm or less, and a fibrous support material contained in the flexible base material and having an average fiber diameter width of 10 μm or more and 1.0 mm or less.

### CROSS-REFERENCE TO RELATED APPLICATION

The present application claims priority from Japanese Patent Application No. 2023-099936 filed on Jun. 19, 2023, the content of which is hereby incorporated by reference into this application.

### TECHNICAL FIELD

The present invention relates to a plastic soft composition and a scuffing processing method, particularly, a plastic soft composition suitable for forming a large number of irregularities on a surface of a treated face as a pre-treatment (scuffing processing) for painting of a painting surface or the like of an article, and a scuffing processing method using it.

### BACKGROUND

In painting a surface of an article (for example, a body of an automobile and its component, etc.), a pre-treatment (scuffing processing) in which its painting surface (treating face) is uniformly sanded (roughened) before the painting in order to enhance adhesiveness of surfacer and paint on the painting surface is generally performed.

Conventionally, this scuffing processing is often performed by using water-resistant paper and polishing cloth, etc. to do dry sanding or wet sanding work. More specifically, as shown in FIGS. 4 and 5, the scuffing processing before the painting is generally performed to a hard wooden holder block 50, a soft or hard sponge pad 60, or the like by attaching a sandpaper 52 to a magic sheet 51 and sanding the entre treated face. The above-mentioned treatment is the same even when a treated face 100 is a curved surface. Incidentally, FIG. 4 and FIG. 5 are diagrams for explaining the above-described scuffing processing method, and are diagrams viewed from a side surface so that a contact state can be understood.

Further, as a scuffing abrasive capable of improving an appearance of a product by efficiently uniformizing irregularities of the treated face, the scuffing abrasive including the followings is known: a cloth base material; a plurality of three-dimensional elements including abrasive grains and a binder; and an adhesion layer provided on one surface side of the cloth base material and joining the cloth base material and the three-dimensional elements (see, for example, Patent Document 1 (Japanese Patent Application Laid-open No. 2018-108613)).

In addition, although not used for the scuffing processing, a plastic soft composition, in which fine particles for polishing are contained in a flexible base material having plasticity for performing a polishing treatment and a coating treatment to a treated face (see, for example, Patent Documents 2 (Japanese Patent Application Laid-open No. 2010-240751)), is known.

### SUMMARY

Further, in recent years, there are many cases where mirror surface painting is required to the treated face 100 whose surface is a complicated curved surface. In those cases, high quality is needed in repair work, so that difficulty of the work is known as time-consuming work in sheet metal industry.

However, in the above method, when the treated face 100 is the curved surface, it is difficult to perform the uniform scuffing processing. That is, by using the hard wooden holder block 50, it is possible to effectively and uniformly perform the scuffing processing to the flat treated face. However, to the curved treated face, contact points are limited to specific parts, and it is difficult to uniformly perform the scuffing processing.

In addition, the sponge pad 60 with the magic sheet 51 can contact with the curved treated face 100, but a palm pressure is likely to be applied to fingertips and the lopsided pressure is applied to the treated face, so that it is difficult to uniformly perform the scuffing processing after all. Furthermore, when the sponge pad is deformed to follow the curved surface, a pressure on a contracting part of the sponge increases, and a pressure on a not-contracting part of the sponge becomes lower than that of the contracting part and the pressure applied to the treated face becomes uneven. (For example, in FIG. 5, the pressure at a center portion of the sponge pad 60 is high, and the pressure at left and right end portions is weaker than that of the center portion). Since a polishing force varies depending on magnitude of the pressure applied to the treated face, it is difficult to perform the uniform scuffing processing with these methods.

The scuffing processing is important work that affects quality of finish of the painting, and it is required to perform this scuffing processing uniformly, especially when the mirror surface painting is performed, it is necessary to pay close attention. Therefore, as described above, when it is difficult to perform the uniform scuffing processing to the curved treated face, the treatment depends on a personal technique of an artisan(s), for example, adjustment of the scuffing processing by the skilled artisan is necessary and the like.

Further, in the scuffing abrasive disclosed in Patent Document 1, a height, a shape, and an arrangement, etc. of the three-dimensional element that holds the abrasive grains are aligned according to purposes, thereby intending to make it possible to uniformly roughen the treated face by uniformly dispersing loads to the treated face. However, it is still difficult to need to prepare the cloth base material having the three-dimensional elements with predetermined heights, arrangements, and shapes according to the shape of the treated face and to keep the pressure on the treated face constant in order for the base material to be the cloth base material when the treated face is the curved surface.

In addition, the plastic soft composition disclosed in Patent Document 2 intends to perform the polishing treatment and the coating treatment without damaging the painting surface, and is not used for the scuffing processing.

Therefore, the present invention has as its purpose to provide a novel plastic soft composition that facilitates the uniform performance of the scuffing processing without relying on the artisan skills as described above even if the treated face is the curved surface in spite of the simple configuration thereof.

A plastic soft composition for scuffing according the present invention includes: a flexible base material having plasticity; a particulate abrasive contained in the flexible base material and having an average particle size of 10 μm or more and 1.5 mm or less; and a fibrous support material contained in the flexible base material and having an average fiber diameter of 10 μm or more and 1.0 mm or less.

A scuffing processing method of the present invention includes: a step of contacting a plastic soft composition with a treated face, applying a pressure to it so as to follow a shape of the treated face, and plastically deforming it; and a step of performing a scuffing processing to the treated face by frictionally moving the plastic soft composition, which contacts with the treated face, along the treated face, in which the plastic soft composition has: a flexible base material having plasticity; a particulate abrasive contained in the flexible base material and having an average particle size of 10 μm or more and 1.5 mm or less; and a fibrous support material contained in the flexible base material and having an average fiber diameter width of 10 μm or more and 1.0 mm or less.

According to the plastic soft composition and the scuffing processing method, even if the treated face is the curved surface in spite of a simple configuration, the novel plastic soft composition and the scuffing processing method using it, which facilitate the uniform performance of the scuffing processing, can be provided.

### DRAWINGS

FIG. 1 is a diagram showing a schematic configuration of a plastic soft composition that is one embodiment of the present invention;

FIG. 2 is a diagram for explaining a scuffing processing method to a treated face, the method using the plastic soft composition which is one embodiment of the present invention;

FIG. 3 is a drawing showing a schematic configuration when the plastic soft composition, which is one embodiment of the present invention, is fixed to polishing equipment;

FIG. 4 is a diagram for explaining a scuffing processing method to a treated face, the method using a conventional wooden holder block; and

FIG. 5 is a diagram for explaining a scuffing processing method to a treated face, the method using a conventional sponge pad.

### PREFERRED EMBODIMENTS

In the embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof.

Also, in the embodiments described below, when referring to the number of elements (including number of pieces, values, amount, range, and the like), the number of the elements is not limited to a specific number unless otherwise stated or except the case where the number is apparently limited to a specific number in principle, and the number larger or smaller than the specified number is also applicable.

Further, in the embodiments described below, it goes without saying that the components (including element steps) are not always indispensable unless otherwise stated or except the case where the components are apparently indispensable in principle. Also, even when mentioning that constituent elements or the like are “made of A” or “made up of A” in the embodiments below, elements other than A are of course not excluded except the case where it is particularly specified that A is the only element thereof.

Similarly, in the embodiments described below, when the shape of the components, positional relation thereof, and the like are mentioned, the substantially approximate and similar shapes and the like are included therein unless otherwise stated or except the case where it is conceivable that they are apparently excluded in principle. The same goes for the numerical value and the range described above.

Still further, when the materials and the like are mentioned, the specified material is a main material unless otherwise stated or except the case where it is not so in principle or situationally, and the secondary components, additives, additional components and the like are not excluded.

Also, components having the same function are denoted by the same reference characters in principle throughout the drawings for describing the embodiments, and the repetitive description thereof will be omitted.

Also, in some drawings used in the following embodiments, hatching is omitted even in a cross-sectional view so as to make the drawings easy to see. In addition, hatching is used even in a plan view so as to make the drawings easy to see.

A plastic soft composition and a scuffing processing method that are one embodiment of the present invention will be described in detail below with reference to the drawings.

### [Plastic Soft Composition]

FIG. 1 is a diagram for explaining a schematic configuration of a plastic soft composition of the present embodiment. As shown in FIG. 1, a plastic soft composition 10 is configured to include a flexible base material 11 having plasticity, particulate abrasives 12 contained in the flexible base material 11, and fibrous support materials 13. Each component configuring the plastic soft composition 10 will be described in detail below.

### <Flexible Base Material>

The flexible base material 11 used here is a flexible base material having plasticity. The flexible base material 11 is made of a material that has plastic at least during use, and may be made of a material that has always plastic regardless of whether it is in use or not. In addition, since water is often sprayed on a treated face during the use, the material may be a material that develops plasticity when contacting with water. As quality of materials for the flexible base material 11, for example, petroleum-based resins such as polyolefin polyol, polybutene, and butyl rubber, etc. can be raised.

Since the flexible base material 11 has plasticity, a contact state between the flexible base material and the treated face can be made better by plastic deformation of the flexible base material 11 following the shape of the treated face in applying the pressure with a contact of the flexible base material with the treated face in order to perform the scuffing processing.

In addition, since the plastic soft composition 10 of the present embodiment has the flexible base material 11 as a main component, the shape of the plastic soft composition can be easily deformed into an arbitrary shape. Although FIG. 1 shows a diagram of a rectangular parallelepiped shape thereof as an example, the shape of the present embodiment is not limited to this and can also be deformed into an arbitrary shape as if a user were to handle clay.

### <Particulate Abrasive>

The particulate abrasive 12 used here is an abrasive for performing the scuffing processing, and is mixed with the flexible base material 11 described above, is dispersed in the flexible base material 11, and exists therein. The present embodiment contains the particulate abrasive 12 as an essential component of the abrasive, but may contain other abrasives.

This particulate abrasive 12 is used to perform the scuffing processing to the treated face, and needs to be blended so that the surface of the flexible base material 11 or part of the particulate abrasive 12 is exposed. This is because if the particulate abrasive 12 is not exposed, the scuffing processing cannot be sufficiently performed.

By exposing the particulate abrasive 12 from the surface in this way, the treated face can be performed by repeating an operation (frictionally moving) to be pressed against and rub the treated face. A type and a blending amount of particulate abrasive 12 can be varied in accordance with a type of treated face and a state of the required scuffing processing, etc.

The particulate abrasive 12 used here is a particulate abrasive for performing the scuffing processing to the surface of the treated face, and a conventionally known particulate adhesive can be used as this type of abrasive without being particularly limited. It is preferable that the particulate abrasive 12 has a new Mohs hardness of 8 or more, which is relatively high.

As this particulate abrasive 12, for example, alumina-based particles such as blast abrasive (fused alumina), calcium carbonate, quartz, emery (silicon carbide), ceramics, green carborundum, glass beads, and the like are raised, and at least one type selected from those particulars may be contained. That is, each of these particulate abrasives may be used alone, or two or more types of them may be mixed.

The blast abrasive is a white fused alumina abrasive with a high alumina content, and is composed of aluminum oxide as a chemical component. The blast abrasive is an abrasive that is often used for sandblasting and a general abrasive (new Mohs hardness: 12, Knoop hardness: HK2050, true specific gravity: 3.97 g/cm³, bulk specific gravity: 1.60 to 1.80 g/cm³). Emery is particles made of silicon carbide, and is an abrasive well known as abrasive particles (new Mohs hardness: 10).

This particulate abrasive 12 is used for the scuffing processing as described above. This particulate abrasive 12 is mixed and dispersed in the plastic soft composition, and its part is exposed on the surface of the plastic soft composition. By the exposure in this way, the scuffing processing to the treated face can be performed by contacting the plastic soft composition with the treated face and frictionally moving it.

In order to cause it to exert action as mentioned above, the particulate abrasive 12 has an average particle size of 10 μm or more and 1.5 mm or less, preferably an average particle size of m or more and 1.5 mm or less. Furthermore, the average particle size is preferably 10 μm or more and 500 μm or less, more preferably 20 μm or more and 300 μm or less. If the average particle size is less than 10 m, the scuffing processing may be unable to be performed sufficiently. Further, if the average particle size is more than 1.5 mm, a depth of the scuffing to the treated face may become overly large and dispersibility of the particulate abrasive may become insufficient. Here, the average particle size is a value measured by a laser diffraction/scattering method.

### <Fibrous Support Material>

The fibrous support material 13 used here is a material that supports the particulate abrasive 12 described above, is mixed with the flexible base material 11 described above and dispersed in the flexible base material 11, and exists therein.

The fibrous support material 13 used here is not particularly limited as long as it exhibits the above action. As the fibrous support material 13, conventionally known fibrous abrasives can also be used. The use of the fibrous abrasive is preferred because it not only supports the particulate abrasive 12 but also is capable of performing the scuffing processing to the treated face. As the fibrous support material 12, for example, metal fibrous abrasives such as steel wool, stainless wool, and curlkate are preferable.

Steel wool is known as an iron abrasive used for polishing work and finishing work, etc. of industrial products. There are various types such as Number 0000 ultra-fine, Number 000 Extra Fine, Medium Fine, Fine, Rough, Medium Rough, Extra Rough, Number 5 ultra-coarse. Curlkate is an abrasive made of copper, and stainless wool is an abrasive made of stainless steel.

The fibrous support material 13 has a function of supporting the particulate abrasive 12 with the fibers of the fibrous support material 13, as described above. This makes it possible to adjust time for the particulate abrasive 12 to fall off from the plastic soft composition 10 to an outside and expose from an inside to an outer surface of the plastic soft composition 10 when continuing the scuffing processing with the plastic soft composition 10.

For example, it is assumed that in a cross-sectional view orthogonal to a length direction (fiber length direction) of the fibrous support material 13, a width in a direction orthogonal to a thickness (about 3 μm) of the fibrous support material 13 is called a “fiber diameter width”. Then, the fibrous support material 13 has an average fiber diameter width of 10 μm or more and 1.0 mm or less in order to exhibit action as mentioned above. Furthermore, the average fiber diameter width is preferably 10 μm or more and 500 μm or less, more preferably 20 μm or more and 300 μm or less. If the average fiber diameter width is less than 10 μm, this may easily deform the plastic soft composition and support action of the particulate abrasive 12 may be insufficient. In addition, if the average fiber diameter width is more than 1.0 mm, this may be difficult to deform the plastic soft composition 10 and may block action for the plastic soft composition 10 to follow the curved shape of the treated face.

The average fiber length of the fibrous support material 13 is preferably 5 mm or more and 30 mm or less, more preferably 10 mm or more and 20 mm or less.

### <Blending Rate>

As described above, the plastic soft composition of the present embodiment mixes the particulate abrasive 12 and the fibrous support material 13 in the flexible base material 11, and contains mixture obtained by dispersing these components in the flexible base material.

Here, a blending amount of particulate abrasive 12 is 5 parts by mass or more and 50 parts by mass or less with respect to 100 parts by mass of the flexible base material. Furthermore, the blending amount of particulate abrasive 12 is preferably 10 parts by mass or more and 40 parts by mass or less, more preferably 20 parts by mass or more and 30 parts by mass or less with respect to 100 parts by mass of the flexible base material. By mixing the particulate abrasive 12 into the flexible base material 11 at such a blending rate, part of the particulate abrasive 12 is exposed on the surface of the flexible base material 11, which can be used as a preferred configuration for polishing applications.

Here, the blending amount of fibrous support material 13 is 2 parts by mass or more and 50 parts by mass or less with respect to 100 parts by mass of the flexible base material. Furthermore, the blending amount of fibrous support material 13 is preferably 2 parts by mass or more and 5 parts by mass or less, more preferably 3 parts by mass or more and 4 parts by mass or less with respect to 100 parts by mass of the flexible base material. By mixing the fibrous support material 13 into the flexible base material 11 in such a blending rate, the particulate abrasive 12 can be supported by the fibers in the flexible base material 11.

Further, the blending rate of the particulate abrasive 12 and the fibrous support material 13 is preferably in a range of 10:2 to 10:4, more preferably a range of 10:2.5 to 10:3 at a mass ratio. By setting the blending rate to the above-mentioned range, the polishing action and the supporting action of the abrasive can be exhibited in a well-balanced manner.

### [Scuffing Processing Method]

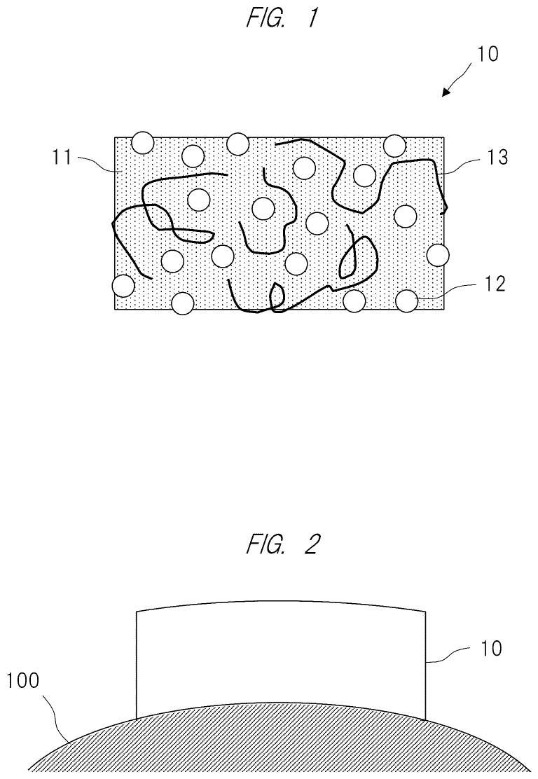

Next, a scuffing processing method to the treated face, which uses the above-explained plastic soft composition, will be described with reference to FIG. 2. Incidentally, FIG. 2 is a diagram for explaining this scuffing processing method, and is a diagram viewed from a side surface so that the contact state can be understood.

As shown in FIG. 2, the scuffing processing method of the present embodiment first contact the above-mentioned plastic soft composition 10 with the treated face 100 of the article, then applies the pressure to it so as to follow the shape of the treated face, thereby plastically deforming it (plastic deformation step).

At this time, the flexible substrate material 11 plastically deforms according to the shape of the treated face 100, so that even if the treated face 100 has the curved surface, it can easily deform into a shape corresponding to the shape of the curved surface and can ensure the homogeneous contact state with respect to the treated face 100.

In addition, in order to facilitate the deformation of the plastic soft composition 10 following the shape of the treated face 100, the plastic deformation step may be performed while heating the plastic soft composition 10.

After being plastically deformed, by frictionally moving the plastic soft composition 10 along the treated face 100, the scuffing processing for forming the irregularities on the treated face 100 is performed (scuffing step).

Incidentally, in this scuffing processing, after water or the like is sprayed on the treated face 100, each of the above-mentioned steps is performed. By allowing water to exist on the surface of the treated face 100 in this manner, Kirikos (shavings) generated during the scuffing processing can be washed away together with the water, and the scuffing processing can be performed efficiently.

At this time, as described above, part of the particulate abrasive 12 contained in the plastic soft composition 10 is exposed from the surface of the flexible base material 11. Therefore, by frictionally moving the plastic soft composition 10 with its contacting with the treated face 100, the particulate abrasive 12 exposed on the surface of the plastic soft composition 10 forms the irregularities on the treated face 100, and the scuffing processing can be performed thereto.

At this time, since the particulate abrasive 12 is contained and held in the flexible base material 11, unlike the conventional technique, the particulate abrasive 12 is not fixed and can be polished while rolling. Also, at that time, some of Kirikos are taken into the flexible base material 11, but its most are discharged and removed exteriorly from between the treated face 100 and the plastic soft composition 10 together with the water on the treated face 100.

Further, at this time, since the fibrous support material 13 exhibits action to support the particulate abrasive 12 in the flexible base material 11, it exhibits action to suppressing the falling off of the flexible soft composition 10 to the outside while the particulate abrasive 12 is moving in the flexible base material 11, and can maintain the scuffing action of the plastic soft composition 10 for a long time.

Incidentally, the surface of the article is not particularly limited, and articles made of various types of quality of materials such as metal, a wood, a resin, and a stone can be also used. In addition, the term “scuffing processing” as used here includes not only a scuffing processing as the pre-treatment for the painting step but also a treatment of simply unevenly scratching the surface of the article without the painting. A typical example of this scuffing processing method is a scuffing processing performed in a pre-treatment of coated faces of an automobile body, and its component parts, etc.

### First Modification Example

In the above-mentioned plastic soft composition 10, an active agent having cleaning action can further be blended with the flexible base material 11. By containing the active agent having the cleansing action in this way, at the same time as the scuffing processing, the scuffing processing can be performed while cleaning the treated face with the active agent.

By performing the scuffing processing while washing in this way, the treated face immediately after being treated with the plastic soft composition 10 can be kept clean, so that the next painting step can be performed immediately. For example, when oil stains adhere onto the treated face 100, the oil stains themselves cannot be removed by the scuffing processing. However, by containing the above-mentioned active agent in the plastic soft composition, the oil stains can be effectively removed.

When the active agent having this cleaning action is blended, the blending amount is preferably 0.2 parts by mass or more and 0.5 parts by mass or less with respect to 100 parts by mass of the flexible base material, more preferably 0.2 parts by mass or more and 0.3 parts by mass or less in order to effectively exhibit cleaning effects.

### Second Modification Example

In the above-mentioned plastic soft composition 10, a water-soluble softening component as part of the flexible base material 11 can further be used. As this softening component, for example, natural clay and the like are raised.

By blending the water-soluble softening component in this way, when the softening component is exposed on the surface of the flexible base material 11 while the scuffing work is continuously progressed, the softening component dissolves by the water sprayed on the treated face 100 and new particulate abrasive 12 can be exposed to the surface of the plastic soft composition 10. Incidentally, it is preferable that this softening component has plasticity.

Thus, the newly exposed particulate abrasive 12 can contribute to the subsequent scuffing processing. That is, adopting the above-mentioned configuration makes it possible to sufficiently expose the particulate base material 12 on the surface of the plastic soft composition 10 even after long-term use and to maintain scuffing performance.

When this softening component is blended, its blending amount is preferably 0.2 parts by mass or more and 1.5 parts by mass or less with respect to 100 parts by mass of the flexible base material, more preferably 0.3 parts by mass or more and 0.8 parts by mass or less in order to effectively exhibit the above-mentioned action.

### Third Modification Example

The above-mentioned plastic soft composition 10 may be fixed to polishing equipment. Since the plastic soft composition 10 is configured by uniformly dispersing the particulate abrasive 12 in the flexible base material 11, the part of the particulate abrasive 12 is exposed from the surface of the flexible base material 11 not only on a surface, which causes it to contact with the treated face, but also on other surfaces.

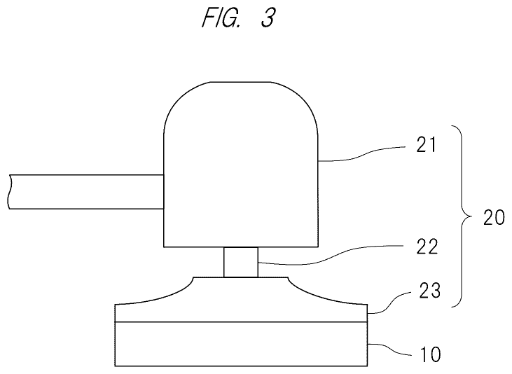

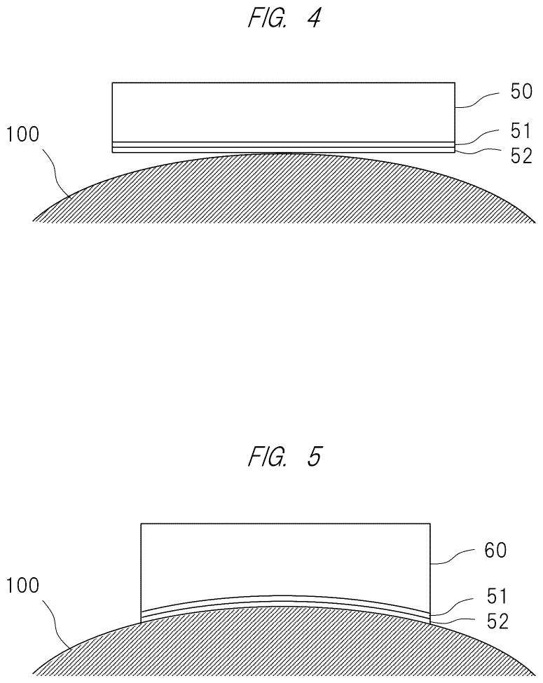

Accordingly, if the plastic soft composition 10 is directly held by a hand(s) and the scuffing processing is performed thereto as it is, a palm(s) and fingers may be injured. Therefore, in order to be able to use it more safely, the plastic soft composition 10 is preferably configured so as to fix it to the polishing equipment and be capable of performing the scuffing processing. FIG. 3 shows a schematic configuration when the plastic soft composition of the present embodiment is fixed to the polishing equipment.

The polishing equipment used here may be any polishing equipment capable of performing operations of the scuffing processings such as rotary motion, reciprocating motion, and vibration. For example, as the polishing equipment capable of performing the scuffing processing by the rotary motion, as shown in FIG. 3, a main body 21, a rotary drive shaft 22 extending from the main body 21, and a fixing portion 23 attached to the rotary drive shaft 22 can be exemplified.

By fixing the plastic soft composition 10 to the fixing portion 23 of the polishing equipment 20, the scuffing processing to the plastic soft composition 10 can be performed with respect to the desired treated face without directly holding or the like the plastic soft composition 10 by the hand.

As fixing means to the fixing portion 23, for example, the fixing etc. with an adhesive layer can be exemplified, and other known fixing methods can be used.

### Embodiment

Next, the present invention will be described in more detail by way of an embodiment.

Polyolefin polyol is used as the flexible base material, and 25 g of emery having an average particle size of 300 μm as the particulate abrasive, 5 g of steel wool having an average fiber diameter width of 20 μm as the fibrous support material, and 10 g of alumina sand as another component are mixed in 100 g of this flexible base material, thereby having produced the plastic soft composition.

After water is sprinkled on a surface of a plate-like member of a vehicle painting surface, which has a curved surface of a curvature of 300R, as the treated face, the obtained plastic soft composition has been pressed against the above-mentioned surface by the hand, and has been plastically deformed into the shape of the treated face. When it is sufficiently adapted to the surface shape, the plastic soft composition has been moved along the surface while being rubbed and the scuffing processing has been performed by reciprocating this movement about 3 to 5 times.

After using a rubber squeegee to remove the water from the surface and drying the treated face, it has been confirmed that the scuffing processing is performed almost uniformly when the surface after the scuffing processing is visually observed. Furthermore, when measured with a Mitutoyo surface roughness meter Surftest, average roughness before the measurement has been 3 μm, but the roughness after the treatment has been 3 to 8 μm by the measurement.

Incidentally, the present invention is not limited to the description of the above-mentioned embodiment, and can be embodied by modifying the components without departing from the scope of the present invention and can be variously modified by appropriate combinations of the plurality of components disclosed in the embodiment, addition of other known devices, and the like.

What is claimed is:

1. A plastic soft composition comprising:
a flexible base material having plasticity;
a particulate abrasive contained in the flexible base material and having an average particle size of 10 μm or more and 1.5 mm or less; and
a fibrous support material contained in the flexible base material and having an average fiber diameter of 10 μm or more and 1.0 mm or less.

2. The plastic soft composition according to claim 1,
wherein the flexible base material is configured from a resin material containing at least one type selected from polyolefin polyol, polybutene, and butyl rubber.

3. The plastic soft composition according to claim 1,
wherein the particulate abrasive contains at least one type selected from alumina particles, emery, and glass beads.

4. The plastic soft composition according to claim 1,
wherein the fibrous support material contains at least one selected from steel wool, curlkate, and stainless wool.

5. The plastic soft composition according to claim 1,
wherein when the flexible base material is 100 parts by mass, the plastic soft composition contains 5 parts by mass or more and 50 parts by mass or less of the particulate abrasive.

6. The plastic soft composition according to claim 5,
wherein when the flexible base material is 100 parts by mass, the plastic soft composition contains 2 parts by mass or more and 50 parts by mass or less of the fibrous support material.

7. The plastic soft composition according to claim 1, further comprising an active agent, which has cleaning action, in the flexible base material.

8. The plastic soft composition according to claim 1,
wherein the plastic soft composition is fixed to polishing equipment that allows at least one operation selected from rotation, reciprocation, and vibration.

9. A scuffing processing method comprising:
a step of contacting a plastic soft composition with a treated face, applying a pressure to it so as to follow a shape of the treated face, and plastically deforming it; and
a step of performing a scuffing processing to the treated face by frictionally moving the plastic soft composition, which contacts with the treated face, along the treated face,
wherein the plastic soft composition has:
a flexible base material having plasticity;
a particulate abrasive contained in the flexible base material and having an average particle size of 10 μm or more and 1.5 mm or less; and
a fibrous support material contained in the flexible base material and having an average fiber diameter width of 10 μm or more and 1.0 mm or less.

10. The scuffing processing method according to claim 9,
wherein the treated face is a surface of an article made of metal, wood, resin, or stone.

11. The scuffing processing method according to claim 9,
wherein the treated face is a coated face.
